(19) United States
(12) Patent Application Publication
(10) Pub. No.: US 2026/0317101 A1
(43) Pub. Date: Oct. 15, 2026

(54) SHEET CONVEYANCE APPARATUS

(71) Applicant: CANON KABUSHIKI KAISHA, Tokyo (JP)

(72) Inventor: HIROSHIGE INOUE, Tokyo (JP)

(21) Appl. No.: 19/463,303

(22) Filed: Jan. 29, 2026

(30) Foreign Application Priority Data
Feb. 14, 2025 (JP) 2025-022118

(51) Int. Cl. B65H 9/00; B65H 3/08; B65H 3/48; B65H 9/16

(52) U.S. Cl. CPC B65H 9/004; B65H 3/0808; B65H 3/48; B65H 9/166; B65H 2301/331; B65H 2801/06

(57) ABSTRACT

A sheet conveyance apparatus includes a feeding unit, an image forming portion, a first conveyance unit, and a second conveyance unit. The first conveyance unit includes a first skew-correction portion including a first abutment portion configured to correct skew of the sheet by a leading edge of the sheet abutting against the first abutment portion, and a shift roller pair disposed downstream of the first skew-correction portion in the sheet conveyance direction and configured to move the sheet in a width direction orthogonal to the sheet conveyance direction while nipping the sheet. The second conveyance unit includes a second skew-correction portion including a second abutment portion configured to correct skew of the sheet by the leading edge of the sheet abutting against the second abutment portion.

### BACKGROUND

### Field of the Technology

The present disclosure relates to a sheet conveyance apparatus that conveys sheets.

### Description of the Related Art

Japanese Patent Application Publication No. 2024-110456 discloses an image forming apparatus that includes a registration portion that corrects the skew of a sheet. The registration portion includes a conveyance portion that conveys the sheet in a sheet conveyance direction, and a skew correction portion that conveys the sheet obliquely with respect to the sheet conveyance direction. The skew correction portion includes a reference member, and an obliquely conveying roller that conveys the sheet obliquely toward the reference member. The sheet is conveyed while abutted against the reference member by the obliquely conveying roller, so that the skew of the sheet is corrected.

The registration portion described in Japanese Patent Application Publication No. 2024-110456 corrects the skew by using a so-called side registration system. Thus, a long and linear conveyance path is necessary in the registration portion. For this reason, it is desired that the skew and positional deviation of a sheet can be corrected with high accuracy by using a method different from the side registration system.

### SUMMARY

According to a first aspect of the present disclosure, a sheet conveyance apparatus includes a feeding unit configured to feed a sheet, an image forming portion configured to form an image, on a sheet fed by the feeding unit, at an image forming position, a first conveyance unit disposed between the feeding unit and the image forming position in a sheet conveyance direction and configured to convey the sheet, and a second conveyance unit disposed between the first conveyance unit and the image forming position in the sheet conveyance direction and configured to convey the sheet. The first conveyance unit includes a first skew-correction portion including a first abutment portion configured to correct skew of the sheet by a leading edge of the sheet abutting against the first abutment portion, and a shift roller pair disposed downstream of the first skew-correction portion in the sheet conveyance direction and configured to move the sheet in a width direction orthogonal to the sheet conveyance direction while nipping the sheet. The second conveyance unit includes a second skew-correction portion including a second abutment portion configured to correct skew of the sheet by the leading edge of the sheet abutting against the second abutment portion.

According to a second aspect of the present disclosure, a sheet conveyance apparatus includes a feeding unit configured to feed a sheet, an image forming portion configured to form an image, on a sheet fed by the feeding unit, at an image forming position, a conveyance unit disposed between the feeding unit and the image forming position in a sheet conveyance direction and configured to convey the sheet. The conveyance unit includes a skew correction portion including an abutment portion configured to correct skew of the sheet by a leading edge of the sheet abutting against the abutment portion, and a shift roller pair disposed downstream of the skew correction portion in the sheet conveyance direction and configured to move the sheet in a width direction orthogonal to the sheet conveyance direction while nipping the sheet.

According to a third aspect of the present disclosure, a sheet conveyance apparatus includes a feeding unit configured to feed a sheet, an image forming portion configured to form an image, on a sheet fed by the feeding unit, at an image forming position, a first conveyance unit disposed between the feeding unit and the image forming position in a sheet conveyance direction and configured to convey the sheet, and a second conveyance unit disposed between the first conveyance unit and the image forming position in the sheet conveyance direction and configured to convey the sheet. The first conveyance unit is configured to perform a first skew-correction process of correcting skew of the sheet, and a moving process of moving the sheet, on which the first skew-correction process has been performed, in a width direction orthogonal to the sheet conveyance direction. The second conveyance unit is configured to perform a second skew-correction process of correcting skew of the sheet on which the first skew-correction process and the moving process have been performed by the first conveyance unit. The feeding unit includes a sheet support portion configured to support a sheet, an air blowing portion configured to blow air on an edge portion of the sheet support portion to float the sheet, and a suction feeding portion configured to suck and feed a sheet floated by the air blowing portion.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram illustrating an image forming system of the present embodiment.

FIG. 2 is a cross-sectional view and a plan view illustrating registration units.

FIG. 3 is a block diagram illustrating control blocks of the image forming system.

FIG. 4 is a flowchart illustrating sheet conveyance control.

FIG. 5 is a flowchart illustrating the sheet conveyance control.

FIG. 6 is a cross-sectional view and a plan view illustrating a state where a sheet has reached the nip of a first registration-roller pair.

FIG. 7 is a cross-sectional view and a plan view illustrating a state where the sheet has reached a position immediately in front of a first shift-roller pair.

FIG. 8 is a cross-sectional view and a plan view illustrating a state where a first moving process has been performed on the sheet.

FIG. 9 is a cross-sectional view and a plan view illustrating a state where the sheet has reached the nip of a second registration-roller pair.

FIG. 10 is a cross-sectional view and a plan view illustrating a second lateral-deviation amount of the sheet.

FIG. 11 is a cross-sectional view and a plan view illustrating a state where the sheet has been shifted in a width direction.

### DESCRIPTION OF THE EMBODIMENTS

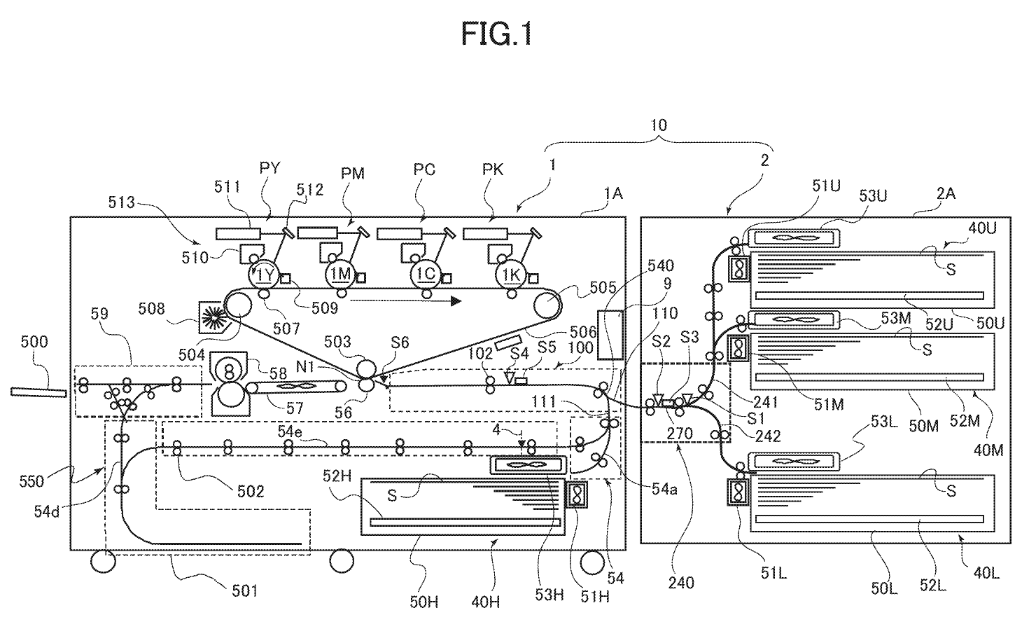

Hereinafter, the present embodiment will be described in detail with reference to the accompanying drawings. As illustrated in FIG. 1, an image forming system 10 that serves as a sheet conveyance apparatus includes an image forming apparatus 1 and a sheet feeding apparatus 2. Examples of the image forming apparatus 1 include a printer, a copying machine, a facsimile, and a multifunction printer; and the image forming apparatus 1 forms an image on a sheet, used as a recording medium, based on image information sent from an external PC or read from a document. In the present embodiment, an electrophotographic full-color laser printer is used as the image forming apparatus 1. Note that although the electrophotographic full-color laser printer is used as the image forming apparatus 1 of the present embodiment, the image forming apparatus may include an ink-jet image forming portion instead of the electrophotographic system.

### Summary of Image Forming Apparatus

The image forming apparatus 1 may be a POD machine that can perform printing performed for work other than general office work. The recording medium may be of various types of sheets including a paper sheet, such as a sheet for any purpose or an envelope, a glossy paper sheet, a plastic film such as an overhead projector sheet (OHT), and a cloth sheet. An apparatus body 1A of the image forming apparatus 1 accommodates a feeding unit 40H that serves a main-body feeding unit for feeding a sheet S, and an image forming portion 513 that forms an image on the sheet S fed from the feeding unit 40H. The image forming portion 513 has a tandem-type intermediate transfer system; and includes four process units PY, PM, PC, and PK, and an intermediate transfer belt 506 that is an intermediate transfer member. The four process units PY, PM, PC, and PK respectively form toner images of yellow, magenta, cyan, and black. The process units PY to PK are electrophotographic units that respectively include photosensitive drums 1Y, 1M, 1C, and 1K that are photosensitive members.

The process units PY to PK have configurations identical to each other except that the colors of toner used for the development are different from each other. Thus, the configuration of the process units and a toner-image forming process (i.e., an image forming operation) will be described with reference to the process unit PY of yellow, as an example. The process unit PY includes, in addition to the photosensitive drum 1Y, an exposure portion 511, a developing portion 510, and a drum cleaner 509. The photosensitive drum 1Y is a drum-shaped photosensitive member that includes a photosensitive layer formed on an outer circumferential portion, and rotates in a direction that is along a rotational direction of the intermediate transfer belt 506. The surface of the photosensitive drum 1Y is supplied with electric charge from a charging portion, such as a charging roller, and is charged with electricity.

The exposure portion 511 forms an electrostatic latent image on the surface of the photosensitive drum 1Y by emitting a laser beam modulated in accordance with image information, to the surface of the photosensitive drum 1Y, and by scanning the surface of the photosensitive drum 1Y with the laser beam by using an optical system that includes a reflecting apparatus 512. The developing portion 510 stores developer that contains toner, and develops the electrostatic latent image into a toner image by supplying the developer to the photosensitive drum 1Y. The toner image formed on the photosensitive drum 1Y is primary-transferred onto the intermediate transfer belt 506 by a primary transfer roller 507. The remaining toner left on the photosensitive drum 1Y after the transfer is removed by the drum cleaner 509.

The intermediate transfer belt 506 is wound around a driving roller 504, a driven roller 505, a secondary transfer inner roller 503, and a plurality of primary transfer rollers 507; and is driven and rotated in a clockwise direction in FIG. 1, by the driving roller 504. The above-described image forming operations in the process units PY to PK are performed in parallel with each other, and multiple transfer is performed so that four-color toner images are put on each other. As a result, a full-color toner image is formed on the intermediate transfer belt 506. The toner image is conveyed to a secondary transfer nip N1 while borne by the intermediate transfer belt 506. The secondary transfer nip N1 is formed by a secondary transfer roller 56 and the secondary transfer inner roller 503. The secondary transfer roller 56 is applied with a bias voltage whose polarity is opposite to the charging polarity of the toner, so that the toner image is secondary-transferred onto the sheet S at an image forming position. That is, the secondary transfer roller 56 is one example of a transfer portion that transfers an image formed on the intermediate transfer belt 506, onto the sheet S. The remaining toner left on the intermediate transfer belt 506 after the transfer is removed by a belt cleaner 508.

The sheet S onto which the toner image has been transferred is delivered to a fixing unit 58 by a pre-fixing conveyance portion 57. The fixing unit 58 includes a fixing roller pair that nips and conveys the sheet S, and a heat source such as a halogen heater; and applies pressure and heat to the toner image borne by the sheet S. As a result, the toner particles are melted and solidify, so that an image fixed to the sheet S can be obtained.

### Sheet Conveyance System of Image Forming Apparatus

Next, a configuration and an operation of a sheet conveyance system will be described. The sheet conveyance system feeds the sheet S stored in a feeding cassette 50H of the feeding unit 40H, and discharges the sheet S onto which an image has been formed, to the outside of the image forming apparatus 1. In general, the sheet conveyance system includes the feeding unit 40H, a conveyance unit 54, a registration unit 100, a branch conveyance portion 59, and a reconveyance portion 550.

The feeding unit 40H includes the feeding cassette 50H, a tray 52H, an air blowing portion 51H, and a suction feeding portion 53H. The feeding cassette 50H is attached to the apparatus body 1A such that the feeding cassette 50H can be drawn off from the apparatus body 1A. The tray 52H is supported by the feeding cassette 50H such that the tray 52H can be lifted and lowered. The tray 52H can be lifted and lowered with respect to the feeding cassette 50H so that the height of the uppermost sheet of a sheet bundle stacked on the tray 52H is kept at a predetermined height. The air blowing portion 51H blows air on a plurality of uppermost sheets of the sheet bundle stacked on the tray 52H. That is, the air blowing portion 51H blows air on an edge portion of the sheet S to float the sheet S.

The suction feeding portion 53H includes a suction belt in which a plurality of holes is formed, and a suction fan which operates for causing the inner side of the suction belt to have a negative pressure. The uppermost sheets S floated by the air blowing portion 51H are sucked by the suction feeding portion 53H; and are fed, one by one, in accordance with the rotation of the suction belt. Note that the method of feeding sheets by the feeding unit 40H is not limited to the above-described belt suction system, and may use a frictional separation system that uses a roller or a pad.

The conveyance unit 54 is one example of a conveyance portion in which a feeding path 54a is formed from the feeding cassette 50H toward the image forming portion 513, and which conveys the sheet in the feeding path 54a. The sheet S fed from the feeding unit 40H is conveyed along the feeding path 54a and a vertical path 111 continuous with the feeding path 54a, and is delivered to the registration unit 100.

In the registration unit 100 that serves as a second conveyance unit, skew correction is performed on the sheet S. After that, the sheet S is sent to the secondary transfer nip N1. The configuration and the operation of the registration unit 100 will be described below.

In the secondary transfer nip N1, a toner image is transferred to the sheet S; and the image is fixed to the sheet S by the fixing unit 58. After that, the sheet S is conveyed to the branch conveyance portion 59 that includes a switching member that can switch the conveyance path of the sheet S. In a case where the image formation on the sheet S has been completed, the sheet S is discharged to a discharging tray 500 disposed outside the apparatus body 1A, by a discharging roller pair of the branch conveyance portion 59.

In a case where the sheet S is discharged to the discharging tray 500 in a state where the printed surface is the bottom surface of the sheet S, the sheet S is temporarily conveyed to a reverse conveyance portion 501 and switch-backed, and then discharged to the discharging tray 500.

In a case where an image is to be formed on the back side of the sheet S, the sheet S is conveyed to the reconveyance portion 550. The reconveyance portion 550 includes the reverse conveyance portion 501 and a duplex conveyance portion 502. In addition, the reconveyance portion 550 reverses the front side and the back side of the sheet on which an image has been formed by the image forming portion 513, conveys the sheet, and sends the sheet into the vertical path 111. The reconveyance portion 550 includes a reversing path 54d that is a reversing path for reversing the conveyance direction of the sheet S, and a reconveyance path 54e that is a duplex conveyance path. The reconveyance path 54e sends the sheet S conveyed from the reversing path 54d, into the vertical path 111.

The sheet S conveyed from the branch conveyance portion 59 is delivered to the duplex conveyance portion 502 that includes the reconveyance path 54e, via the reverse conveyance portion 501 that includes the reversing path 54d. The reverse conveyance portion 501 includes a reversing roller pair that can rotate in a forward direction and a reverse direction, and switch-backs the sheet S and delivers the sheet S to the duplex conveyance portion 502. The leading edge of the sheet S conveyed to the duplex conveyance portion 502 is detected by a detection portion 4 disposed in the reconveyance path 54e for detecting the leading edge of the sheet S. In this case, the sheet S is stopped in the reconveyance path 54e until the sheet S is reconveyed for forming an image on the second side of the sheet (standby for double-side printing).

The detection portion 4 may be an optical sensor. The duplex conveyance portion 502 conveys the sheet S toward the registration unit 100 in synchronization with a timing at which an image is formed on the second side of the sheet. That is, the reconveyance portion 550 temporarily stops the sheet in the reconveyance path 54e, and after that, starts to convey the sheet S toward the registration unit 100. After an image is formed on the back side of the sheet S, the sheet S is discharged to the discharging tray 500.

### Sheet Feeding Apparatus

As illustrated in FIG. 1, the sheet feeding apparatus 2 is disposed upstream of an inlet path 110 of the image forming apparatus 1, and is connected to the image forming apparatus 1. The sheet feeding apparatus 2 includes three feeding units 40L, 40M, and 40U having the same configuration as that of the feeding unit 40H of the image forming apparatus 1 and disposed side by side in the vertical direction. That is, the feeding unit 40L includes a feeding deck 50L, a tray 52L, an air blowing portion 51L, and a suction feeding portion 53L. The feeding deck 50L is attached to an apparatus body 2A of the sheet feeding apparatus 2 such that the feeding deck 50L can be drawn off from the apparatus body 2A. The feeding unit 40M includes a feeding deck 50M, a tray 52M, an air blowing portion 51M, and a suction feeding portion 53M. The feeding deck 50M is attached to the apparatus body 2A of the sheet feeding apparatus 2 such that the feeding deck 50M can be drawn off from the apparatus body 2A. The feeding unit 40U includes a feeding deck 50U, a tray 52U, an air blowing portion 51U, and a suction feeding portion 53U. The feeding deck 50U is attached to the apparatus body 2A of the sheet feeding apparatus 2 such that the feeding deck 50U can be drawn off from the apparatus body 2A. The tray 52U serves as a sheet support portion.

Each of the air blowing portions 51L, 51M, and 51U blows air on a plurality of uppermost sheets of a sheet bundle stacked on a corresponding tray. That is, each of the air blowing portions 51L, 51M, and 51U floats sheets S by blowing air on edges of the sheets S. Each of the suction feeding portions 53L, 53M, and 53U includes a suction belt in which a plurality of holes is formed, and a suction fan which operates for causing the inner side of a corresponding suction belt to have a negative pressure. The uppermost sheets S floated by each of the air blowing portions 51L, 51M, and 51U are sucked by the suction belt of a corresponding one of the suction feeding portions 53L, 53M, and 53U; and are fed, one by one, in accordance with the rotation of the suction belt.

As in the image forming apparatus 1, the sheet S is fed by the feeding unit 40L, 40M, or 40U, in synchronization with an image forming timing of the image forming apparatus 1. The sheet feeding apparatus 2 includes a registration unit 240, and the sheet S fed from the feeding unit 40L, 40M, or 40U is conveyed to the inlet path 110 of the image forming apparatus 1 by the registration unit 240.

More specifically, the sheet S fed from the feeding deck 50M of the feeding unit 40M or the feeding deck 50U of the feeding unit 40U is conveyed to the inlet path 110 of the image forming apparatus 1 via an upper conveyance path 241, by the registration unit 240. The sheet S fed from the feeding deck 50L is conveyed to the inlet path 110 of the image forming apparatus 1 via a lower conveyance path 242, by the registration unit 240.

In addition, a horizontal path 270 extends from a joining portion of the upper conveyance path 241 and the lower conveyance path 242, along a horizontal direction; and a first pre-shift sensor S2 that detects the leading edge of the sheet S is disposed in the horizontal path 270. The first pre-shift sensor S2 may be an optical sensor. If the leading edge of the sheet S is detected by the first pre-shift sensor S2, the registration unit 240 temporarily stops the sheet S.

Then, the registration unit 240 that serves as a first conveyance unit feeds the sheet S again in synchronization with an image forming timing of the image forming apparatus 1, and conveys the sheet S to the image forming apparatus 1. Thus, variations in conveyance timing caused in the feeding units 40L, 40M, and 40U can be corrected in this manner. Note that the feeding units 40L, 40M, and 40U of the sheet feeding apparatus 2 and the registration unit 240 can be controlled by a control portion 9 of the image forming apparatus 1. The configuration of the registration unit 240 will be described in detail below.

The sheet S conveyed in the horizontal path 270 is delivered to the inlet path 110 of the image forming apparatus 1. The vertical path 111 joins with the inlet path 110. The conveyance path from the horizontal path 270 of the sheet feeding apparatus 2 to the discharging tray 500 extends linearly in a substantially horizontal direction. Thus, the conveyance resistance of the sheet can be reduced, and the load and damage to the sheet can be reduced.

### Registration Unit

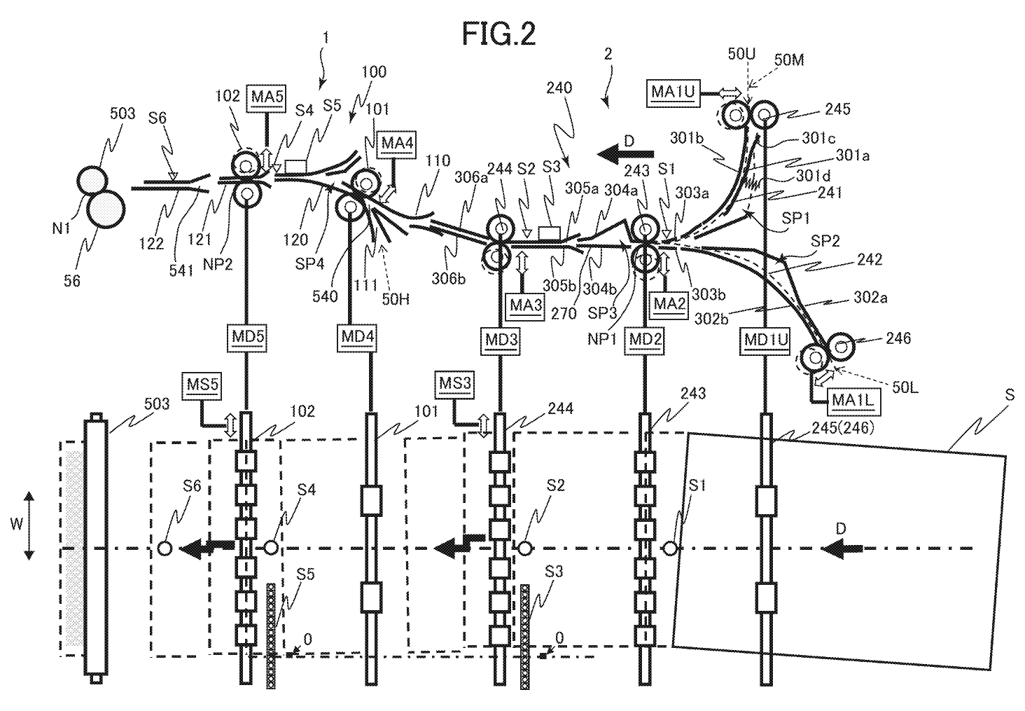

Next, a configuration of the registration unit 240 of the sheet feeding apparatus 2 and a configuration of the registration unit 100 of the image forming apparatus 1 will be described with reference to FIG. 2. FIG. 2 is a cross-sectional view and a plan view illustrating the registration units 240 and 100.

First, the configuration of the registration unit 240 of the sheet feeding apparatus 2 will be described. As illustrated in FIG. 2, the registration unit 240 includes the upper conveyance path 241, the lower conveyance path 242, and the horizontal path 270. The upper conveyance path 241 is formed by a curved guide 301b that serves as a first guide, and a swing guide 301a that faces the curved guide 301b curved along the upper conveyance path 241 and that serves as a second guide. The curved guide 301b and the swing guide 301a constitute a guide portion that guides the sheet, while curving the sheet, toward a first registration-roller pair 243 that serves as a skew correction portion and a first skew-correction portion.

The swing guide 301a can swing on a swing axis 301c, and is urged to a standby position by a spring 301d. At the standby position, the swing guide 301a, together with the curved guide 301b, forms the upper conveyance path 241. In a case where the swing guide 301a swings from the standby position to a retracted position against the urging force of the spring 301d, the swing guide 301a forms a loop space SP1 in the upper conveyance path 241.

The lower conveyance path 242 is formed by a pair of curved guides 302a and 302b. One portion of the curved guide 302a projects outward with respect to the curved guide 302b, and forms a loop space SP2.

The horizontal path 270 is formed by guides 303a and 303b that face each other, guides 304a and 304b that face each other, guides 305a and 305b that face each other, and guides 306a and 306b that face each other. The guides 303a and 303b are disposed upstream of the first registration-roller pair 243 in a sheet conveyance direction D. The guides 304a and 304b, and the guides 305a and 305b are disposed between the first registration-roller pair 243 and a first shift-roller pair 244 in the sheet conveyance direction D. The guides 306a and 306b are disposed downstream of the first shift-roller pair 244 in the sheet conveyance direction D. One portion of the guide 304a projects upward with respect to the guide 304b, and forms a loop space SP3.

The registration unit 240 also includes an upper conveyance-roller pair 245 disposed on the upper conveyance path 241, a lower conveyance-roller pair 246 disposed on the lower conveyance path 242, and the first registration-roller pair 243 and the first shift-roller pair 244 which are disposed on the horizontal path 270. Furthermore, the registration unit 240 includes a first pre-registration sensor S1, the first pre-shift sensor S2, and a first line sensor S3 that are disposed in the horizontal path 270.

The first pre-registration sensor S1 is disposed upstream of the first registration-roller pair 243 and downstream of the joining portion of the upper conveyance path 241 and the lower conveyance path 242 in the sheet conveyance direction D. The first pre-shift sensor S2 and the first line sensor S3 are disposed between the first registration-roller pair 243 and the first shift-roller pair 244 in the sheet conveyance direction D. The first pre-registration sensor S1 and the first pre-shift sensor S2 are disposed in a center portion of the horizontal path 270 in a width direction W orthogonal to the sheet conveyance direction D, and detect the sheet S. The first line sensor S3 is disposed on one side of the horizontal path 270 with respect to the center portion in the width direction W, and detects the position of a side edge SE of the sheet S in the width direction W. For example, the first line sensor S3 is a contact image sensor.

Next, a configuration of the registration unit 100 of the image forming apparatus 1 will be described. The registration unit 100 includes a horizontal path 541 that extends substantially horizontally from a joining portion 540 of the vertical path 111 and the inlet path 110. The horizontal path 541 is formed by guides 120, 121, and 122. The guide 120 is disposed between a conveyance roller pair 101 and a second registration-roller pair 102 that serves as a second skew-correction portion, in the sheet conveyance direction D; and forms a loop space SP4. The guides 121 and 122 are disposed between the second registration-roller pair 102 and the secondary transfer nip N1 in the sheet conveyance direction D.

The registration unit 100 also includes the conveyance roller pair 101 and the second registration-roller pair 102. The conveyance roller pair 101 is disposed downstream of the joining portion 540 in the sheet conveyance direction D, and conveys the sheet S toward the second registration-roller pair 102. The second registration-roller pair 102 is disposed on the horizontal path 541.

Furthermore, the registration unit 100 includes a second pre-registration sensor S4, a second line sensor S5, and a leading-edge sensor S6 that are disposed in the horizontal path 541. The second pre-registration sensor S4 and the second line sensor S5 are disposed between the conveyance roller pair 101 and the second registration-roller pair 102 in the sheet conveyance direction D. The leading-edge sensor S6 is disposed between the second registration-roller pair 102 and the secondary transfer nip N1 in the sheet conveyance direction D.

The second pre-registration sensor S4 and the leading-edge sensor S6 are disposed in a center portion of the horizontal path 541 in the width direction W, and detect the sheet S. In particular, the leading-edge sensor S6 detects the leading edge of the sheet S. Like the first line sensor S3, the second line sensor S5 is disposed on one side of the horizontal path 541 with respect to the center portion in the width direction W, and detects the position of the side edge SE of the sheet S in the width direction W. For example, the second line sensor S5 is a contact image sensor.

### Control Block

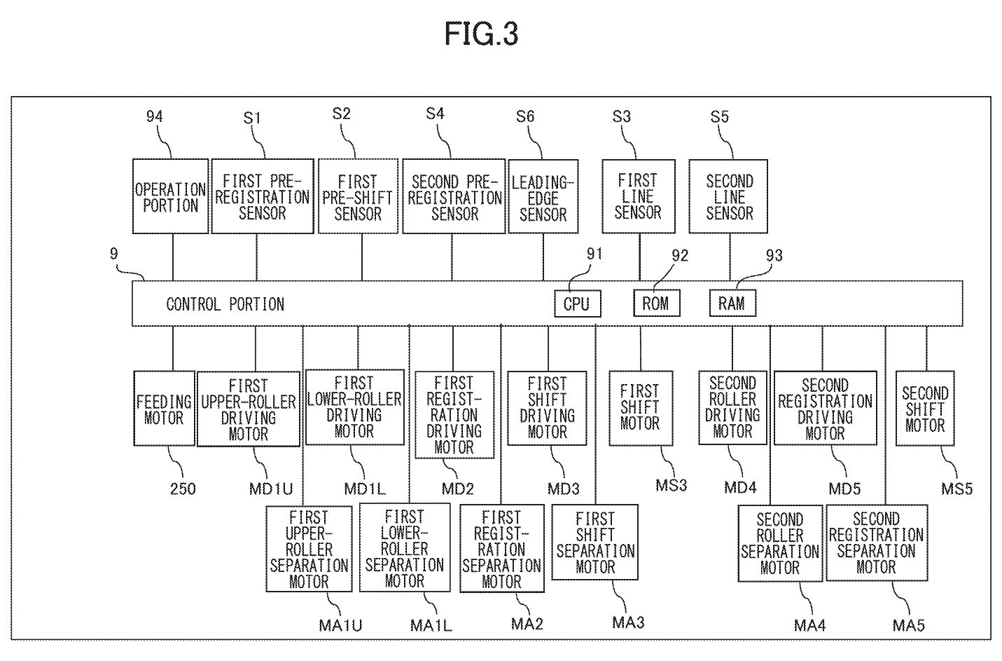

FIG. 3 is a block diagram illustrating control blocks of the image forming system 10. As illustrated in FIGS. 1 and 3, the image forming apparatus 1 of the image forming system 10 includes the control portion 9. The control portion 9 includes a central processing unit (CPU) 91, a read only memory (ROM) 92, and a random access memory (RAM) 93. The CPU 91 reads various programs stored in the ROM 92, and executes the programs. The RAM 93 is used as a work area for the CPU 91.

The control portion 9 is connected with an operation portion 94 which includes a touch panel or physical keys, and through which a user can input various types of setting of the image forming system 10, a start command for a print job, and the like. The input side of the control portion 9 is connected with the first pre-registration sensor S1, the first pre-shift sensor S2, the first line sensor S3, the second pre-registration sensor S4, the second line sensor S5, and the leading-edge sensor S6.

The output side of the control portion 9 is connected with a feeding motor 250, a first upper-roller driving motor MD1U, a first upper-roller separation motor MA1U, a first lower-roller driving motor MD1L, a first lower-roller separation motor MA1L, a first registration driving motor MD2, and a first registration separation motor MA2. Furthermore, the output side of the control portion 9 is connected with a first shift driving motor MD3, a first shift separation motor MA3, a first shift motor MS3, a second roller driving motor MD4, a second roller separation motor MA4, a second registration driving motor MD5, a second registration separation motor MA5, and a second shift motor MS5.

The feeding motor 250 can drive the suction belt of each suction feeding portion. Note that the fan of each air blowing portion and the suction fan of each suction feeding portion may be driven by the driving force from the feeding motor 250, or may be driven by another motor.

As illustrated in FIGS. 2 and 3, the upper conveyance-roller pair 245 that serves as an upstream conveyance-roller pair is driven by the first upper-roller driving motor MD1U, and the nip of the upper conveyance-roller pair 245 is released by the first upper-roller separation motor MA1U. Note that in the following description, driving a roller pair means driving a driving roller of the roller pair by using the motor driving force applied to the driving roller (the driving roller and a driven roller constitute the roller pair). In addition, in the following description, releasing the nip of a roller pair means releasing the nip of the roller pair by separating the driven roller of the roller pair from the driving roller.

The lower conveyance-roller pair 246 is driven by the first lower-roller driving motor MD1L, and the nip of the lower conveyance-roller pair 246 is released by the first lower-roller separation motor MA1L. The first registration-roller pair 243 is driven by the first registration driving motor MD2, and the nip NP1 of the first registration-roller pair 243 is released by the first registration separation motor MA2. The first shift-roller pair 244 is driven by the first shift driving motor MD3, and the nip of the first shift-roller pair 244 is released by the first shift separation motor MA3. Furthermore, the first shift-roller pair 244 can be moved in the width direction W by the first shift motor MS3 in a state where the sheet S is nipped by the first shift-roller pair 244 in the nip.

The conveyance roller pair 101 is driven by the second roller driving motor MD4, and the nip of the conveyance roller pair 101 is released by the second roller separation motor MA4. The second registration-roller pair 102 is driven by the second registration driving motor MD5, and a nip NP2 of the second registration-roller pair 102 is released by the second registration separation motor MA5. Furthermore, the second registration-roller pair 102 can be moved in the width direction W by the second shift motor MS5 in a state where the sheet S is nipped by the second registration-roller pair 102 in the nip NP2.

### Skew Correction Control

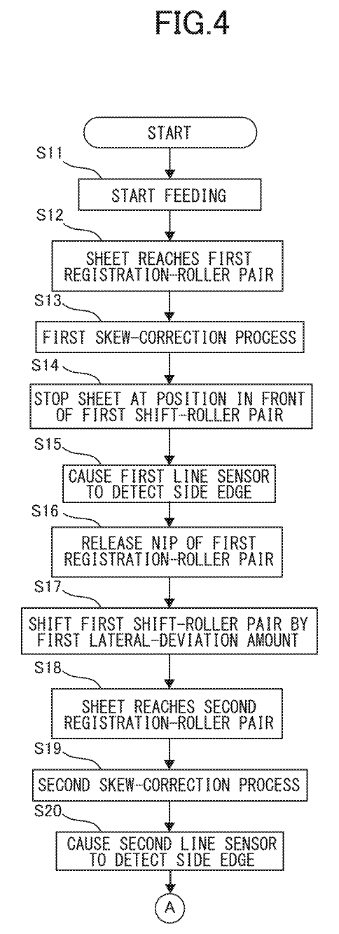

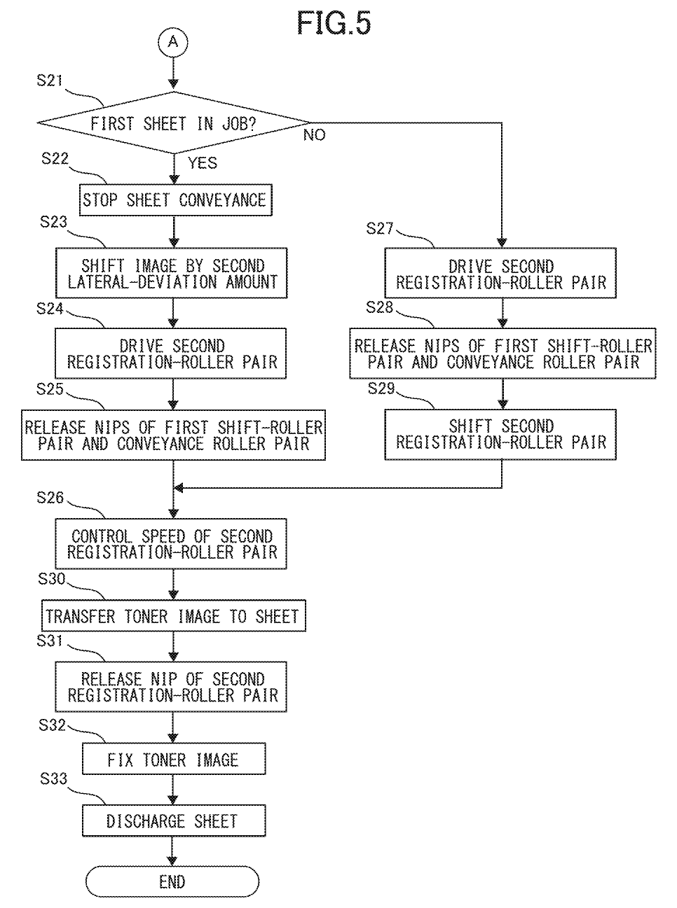

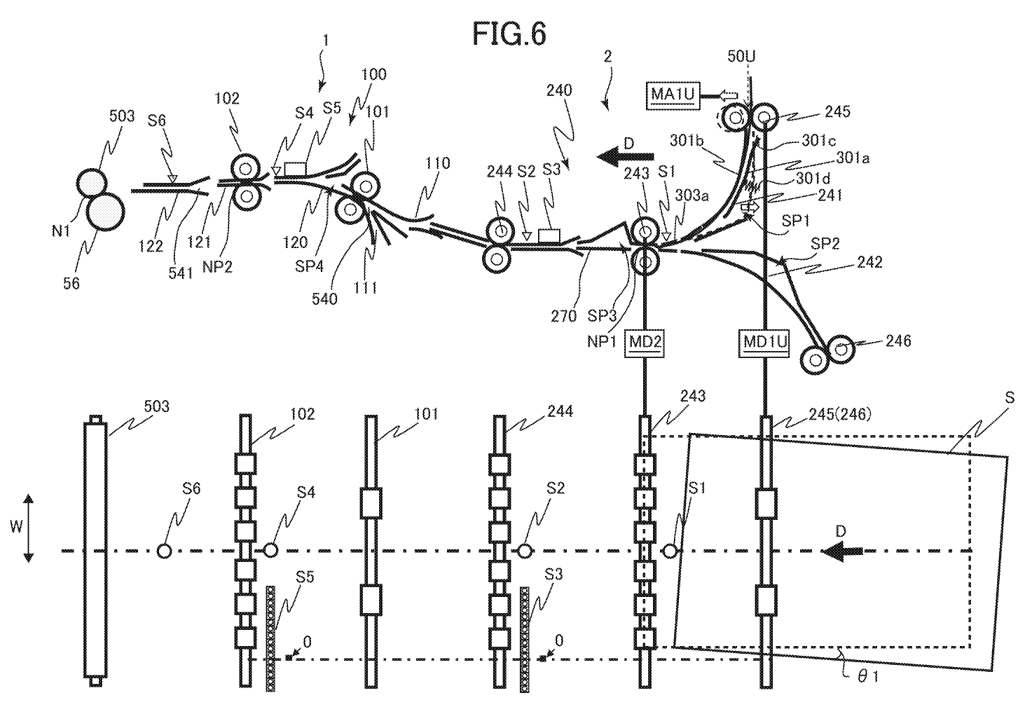

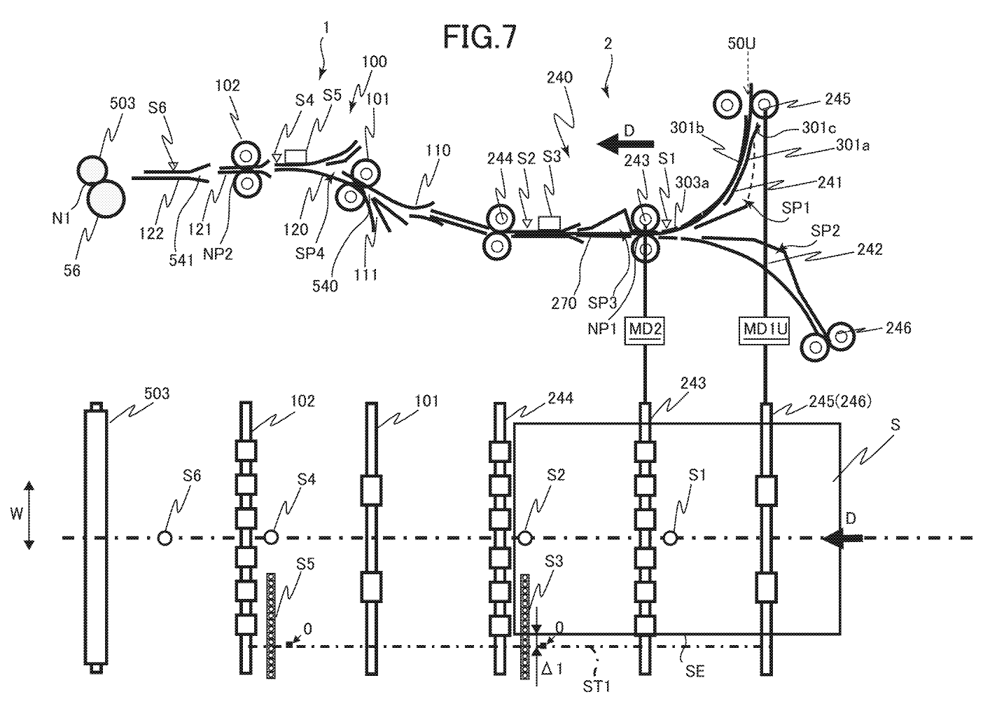

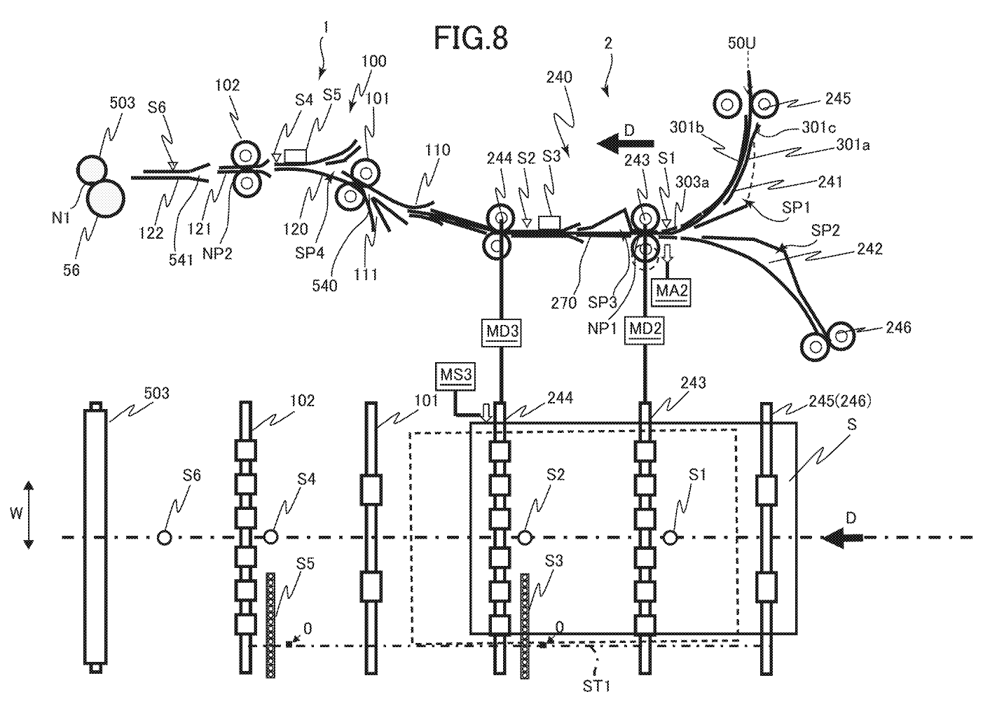

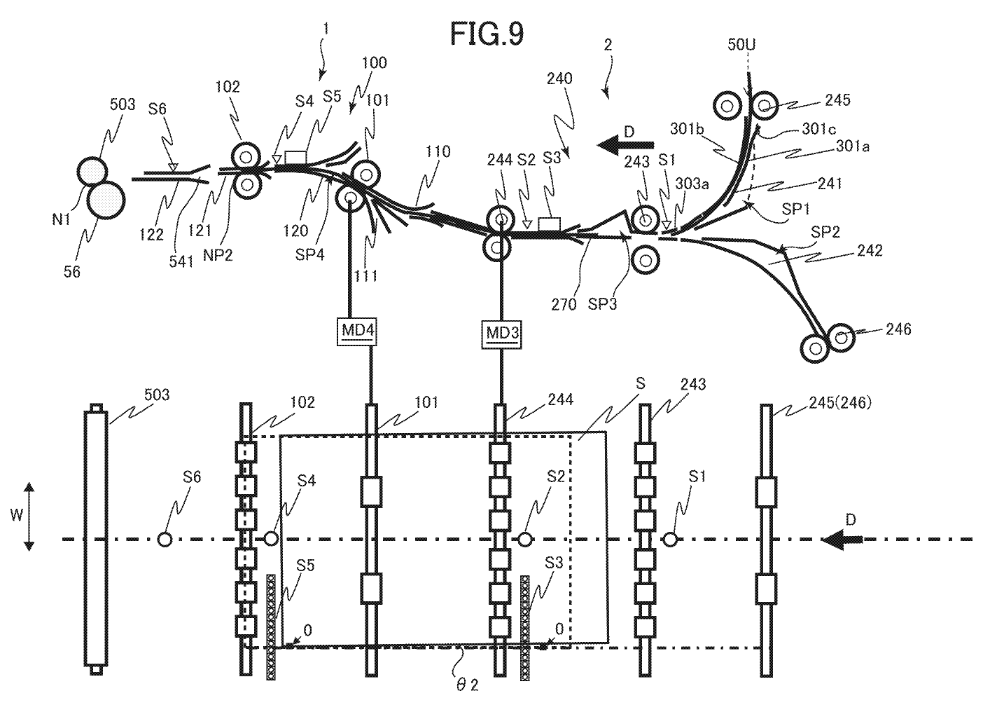

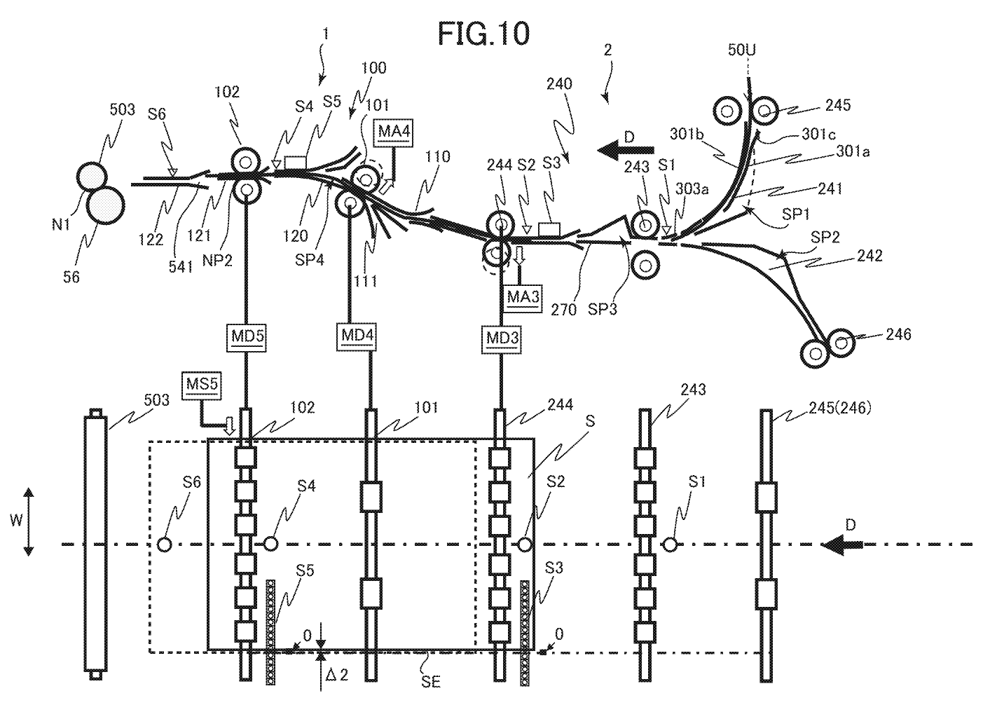

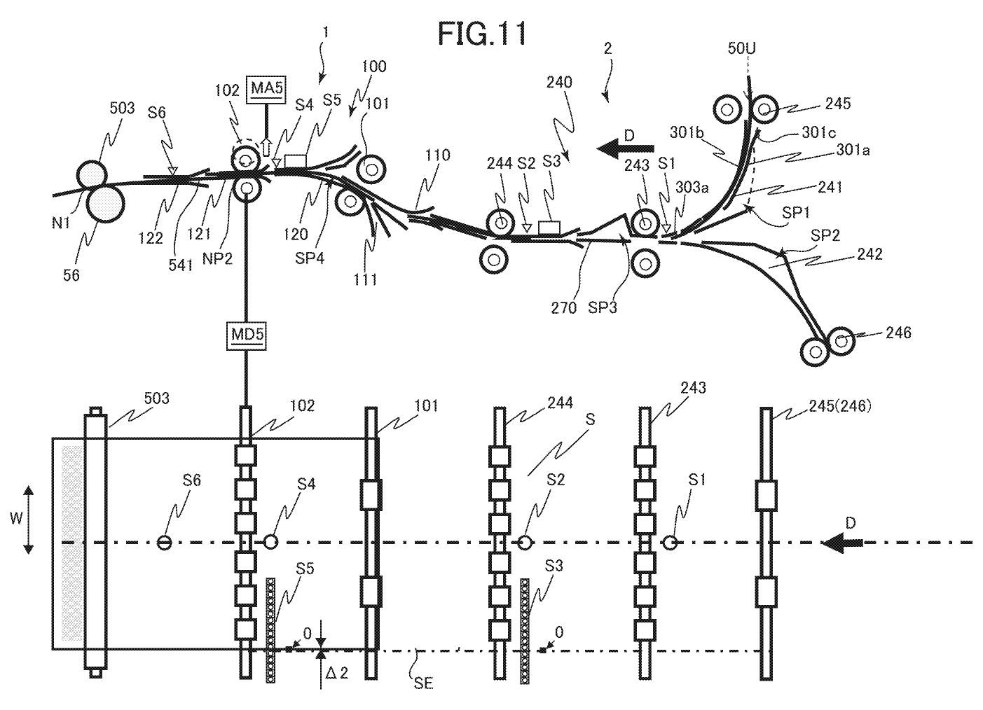

Next, sheet conveyance control of the image forming system 10 will be described with reference to FIGS. 4-11. FIGS. 4 and 5 are flowcharts illustrating the sheet conveyance control. FIG. 6 is a cross-sectional view and a plan view illustrating a state where the sheet S has reached the nip NP1 of the first registration-roller pair 243. FIG. 7 is a cross-sectional view and a plan view illustrating a state where the sheet S has reached a position immediately in front of the first shift-roller pair 244. FIG. 8 is a cross-sectional view and a plan view illustrating a state where a first moving process has been performed on the sheet S. FIG. 9 is a cross-sectional view and a plan view illustrating a state where the sheet S has reached the nip NP2 of the second registration-roller pair 102. FIG. 10 is a cross-sectional view and a plan view illustrating a second lateral-deviation amount Δ2 of the sheet S. FIG. 11 is a cross-sectional view and a plan view illustrating a state where the sheet S has been shifted in the width direction W.

As illustrated in FIG. 4, if the control portion 9 receives a print job, which serves as a job, from an external computer connected to the operation portion 94 or the image forming system 10, then the control portion 9 starts the sheet conveyance control. The print job includes the number of copies specified by a user, and the size of sheets to be printed.

If the sheet conveyance control is started, then the control portion 9 feeds the sheet S from a feeding source specified in accordance with the print job (Step S11). The image forming system 10 includes, as the feeding source, the feeding cassette 50H and the feeding decks 50L, 50M, and 50U. The following description will be made, for example, for a case where the sheet S is fed from the feeding deck 50U. The sheet S fed from the feeding deck 50U passes through the upper conveyance path 241, and is conveyed toward the first registration-roller pair 243 by the upper conveyance-roller pair 245.

Then, the leading edge of the sheet S is detected by the first pre-registration sensor S1 as illustrated in FIG. 6, and after that, the sheet S reaches the nip NP1 of the first registration-roller pair 243 that is in a state where the driving of the first registration-roller pair 243 is stopped (Step S12). The control portion 9 then performs a first skew-correction process (Step S13). Assume that the sheet S is skewed at an angle of θ1 with respect to the sheet conveyance direction D when the sheet S has reached the nip NP1 of the first registration-roller pair 243.

In the first skew-correction process, the control portion 9 stops the first registration-roller pair 243 by stopping the first registration driving motor MD2, and in this state, the control portion 9 drives the first upper-roller driving motor MD1U, based on the detection result of the first pre-registration sensor S1. With this operation, the leading edge of the sheet S abuts against the nip NP1 of the first registration-roller pair 243 that serves as a registration roller pair, and is further conveyed by the upper conveyance-roller pair 245, so that the sheet S forms a loop. The nip NP1 is one example of an abutment portion and a first abutment portion against which the leading edge of the sheet is abutted.

If the loop is formed in the sheet S, the swing guide 301a is pressed by a surface of the sheet S in which the loop is formed, so that the swing guide 301a moves from the standby position to the retracted position. As a result, the loop space SP1 is formed in the upper conveyance path 241 and the leading edge of the sheet S is aligned with the nip NP1, so that the skew of the sheet S is corrected. That is, the sheet S pivots counterclockwise in FIG. 6, by the angle of θ1.

After the skew of the sheet S is corrected, the control portion 9 causes the first registration-roller pair 243 to convey the sheet S in the sheet conveyance direction D, by driving the first registration driving motor MD2. After causing the first registration-roller pair 243 to convey the sheet S by a predetermined distance, the control portion 9 releases the nip of the upper conveyance-roller pair 245 by driving the first upper-roller separation motor MA1U.

Then the control portion 9 stops the sheet S at a position in front of the first shift-roller pair 244, based on the detection result of the first pre-shift sensor S2 (Step S14). After that, the control portion 9 reconveys the sheet S in synchronization with a timing at which the photosensitive drum is exposed by the exposure portion 511. Note that the control portion 9 may not stop the sheet S at a position in front of the first shift-roller pair 244, and may control the conveyance speed of the sheet S in accordance with a timing at which an image is transferred to the sheet S in the secondary transfer nip N1.

The position of the side edge SE of the sheet S in the width direction W is detected by the first line sensor S3 that serves as a side-edge detection portion and a first side-edge detection portion (Step S15). As illustrated in FIG. 7, the control portion 9 calculates a first lateral-deviation amount Δ1 of the side edge SE of the sheet S with respect to a reference position ST1 in the width direction W, based on the detection result of the first line sensor S3. Note that the reference position ST1 is stored in advance in the ROM 92 for each size of the sheet S.

Then, as illustrated in FIG. 8, after the sheet S is conveyed by a predetermined distance by the first shift-roller pair 244, the control portion 9 releases the nip NP1 of the first registration-roller pair 243 by driving the first registration separation motor MA2 (Step S16). Note that the timing at which the nip of the upper conveyance-roller pair 245 is released may be synchronized with the timing at which the nip NP1 of the first registration-roller pair 243 is released. That is, the timing at which the nip of the upper conveyance-roller pair 245 is released may be any timing as long as the nip is released after the sheet S is nipped by the first registration-roller pair 243. In addition, the timing at which the nip NP1 of the first registration-roller pair 243 is released may be any timing as long as the nip NP1 is released after the sheet S is nipped by the first shift-roller pair 244.

Then, the control portion 9 performs a first moving process (i.e., a moving process) (Step S17). Specifically, the control portion 9 moves (or shifts) the first shift-roller pair 244 that is nipping the sheet S and that serves as a shift roller pair, by the first lateral-deviation amount Δ1 in the width direction W, by driving the first shift motor MS3. In this case, since the upper conveyance path 241 is curved, so-called re-occurrence of skew may be caused, as illustrated in FIG. 9. If the re-occurrence of skew is caused, the sheet S pivots and is skewed with respect to the sheet conveyance direction D. Note that in the present embodiment, the first shift-roller pair 244 is moved in the width direction W by the first shift motor MS3 while driven by the first shift driving motor MD3. However, the present disclosure is not limited to this. For example, the first shift-roller pair 244 may be moved in the width direction W by the first shift motor MS3 in a state where the first shift driving motor MD3 is stopped.

Then the sheet S is delivered to the inlet path 110 of the image forming apparatus 1 by the first shift-roller pair 244, and is conveyed toward the second registration-roller pair 102 by the first shift-roller pair 244 and the conveyance roller pair 101. The control portion 9 then performs a second skew-correction process (Step S19). Assume that as illustrated in FIG. 9, the sheet S is skewed at an angle of θ2 with respect to the sheet conveyance direction D when the sheet S has reached the nip NP2 of the second registration-roller pair 102.

In the second skew-correction process, the control portion 9 stops the second registration-roller pair 102 by stopping the second registration driving motor MD5, and in this state, the control portion 9 drives the second roller driving motor MD4, based on the detection result of the second pre-registration sensor S4. With this operation, the leading edge of the sheet S is abutted against the nip NP2 of the second registration-roller pair 102, and is further conveyed by the conveyance roller pair 101, so that the sheet S forms a loop. The loop formed in the sheet S can enter the loop space SP4 formed in the guide 120. In addition, the leading edge of the sheet S is aligned with the nip NP2, so that the skew of the sheet S is corrected. That is, the sheet S pivots clockwise in FIG. 9, by the angle of θ2.

The position of the side edge SE of the sheet S (whose skew has been corrected in the second skew-correction process) in the width direction W is detected by the second line sensor S5 that serves as a second side-edge detection portion (Step S20). As illustrated in FIG. 10, the control portion 9 calculates a second lateral-deviation amount Δ2 of the side edge SE of the sheet S with respect to the reference position ST1 in the width direction W, based on the detection result of the second line sensor S5.

Then the control portion 9 determines, as illustrated in FIG. 5, whether the sheet S is the first sheet in the print job (Step S21). If the control portion 9 determines that the sheet S is the first sheet in the print job (Step S21: YES), then the control portion 9 stops the sheet S in a state where the leading edge of the sheet S is abutted against the nip NP2 of the second registration-roller pair 102 (Step S22). In this state, the second registration driving motor MD5 is stopped. The nip NP2 is one example of a second abutment portion against which the leading edge of the sheet is abutted.

Then the control portion 9 sets a position in which the photosensitive drum is exposed by the exposure portion 511, at a shift position moved from a normal position by the second lateral-deviation amount Δ2 (Step S23). That is, the exposure portion 511 adjusts the position in which the electrostatic latent image is formed in the width direction W, based on the detection result of the second line sensor S5. Note that the normal position is a position in which the center of conveyance on each of the horizontal paths 270 and 541 becomes equal to the center of an image formed in the normal position.

After this operation, the position in which the photosensitive drum is exposed by the exposure portion 511 is the shift position in this print job. That is, in the print job, an image on the second side of the first sheet and images on the second and subsequent sheets are formed in the shift position. In addition, the reference position of the second line sensor S5 becomes a reference position ST2 (not illustrated) moved from the reference position ST1 by the second lateral-deviation amount Δ2 in the width direction W. Note that the exposure portion 511 may form an image on the photosensitive drum (corresponding to Step S23) before Step S22. That is, the exposure portion 511 may form an image on the photosensitive drum at any timing as long as the exposure portion 511 forms the image on the photosensitive drum after the position of the side edge SE of the sheet S is detected by the second line sensor S5 in Step S20.

Then the control portion 9 reconveys the sheet S, as illustrated in FIG. 10, by driving the second registration-roller pair 102 by driving the second registration driving motor MD5 (Step S24). After the sheet S is conveyed by a predetermined distance by the second registration-roller pair 102, the control portion 9 releases the nip of the first shift-roller pair 244 by driving the first shift separation motor MA3, and releases the nip of the conveyance roller pair 101 by driving the second roller separation motor MA4 (Step S25).

On the other hand, if the control portion 9 determines in Step S21 that the sheet S is not the first sheet in the print job (Step S21: NO), then the control portion 9 drives the second registration driving motor MD5 (Step S27). With this operation, the sheet S whose skew has been corrected in the second skew-correction process is reconveyed by the second registration-roller pair 102. Then, as in Step S25, the control portion 9 releases the nip of the first shift-roller pair 244 by driving the first shift separation motor MA3, and releases the nip of the conveyance roller pair 101 by driving the second roller separation motor MA4 (Step S28).

Then the control portion 9 calculates the displacement between the updated reference position ST2 and the position of the side edge SE of the sheet S in the width direction W, detected by the second line sensor S5 in Step S20. That is, the control portion 9 calculates the amount of deviation between the reference position ST2 and the detected position of the side edge SE of the sheet S. Then, the control portion 9 performs a second moving process (Step S29). Specifically, the control portion 9 moves the second registration-roller pair 102 that is nipping the sheet, by the above-described amount of deviation in the width direction W, by driving the second shift motor MS5 (Step S29). With this operation, the sheet S is moved in the width direction W, by the amount of deviation. However, since the amount of deviation is slight, the re-occurrence of skew of the sheet S caused by the moving process in Step S29 hardly occurs.

Note that the skew and the positional deviation (in the width direction W) of the conveyed sheet S are often caused by the wear of a conveyance roller pair, the tolerance of a guide that guides the sheet, and the like. That is, the skew and the positional deviation in the width direction W that occur in the first sheet in a print job often occur by the same amount as that in each of the second and following sheets in the print job. For this reason, in the print job, images for the second side of the first sheet and for the second sheet are formed in the shift position, as described above. Thus, the amount of shift of the sheet S in the width direction W performed by the second registration-roller pair 102 in Step S29 can be reduced, so that the re-occurrence of skew caused by the shift of the sheet can be reduced. In addition, for the second sheet S of a print job, an image is formed in the shift position, based on the position of the side edge SE of the first sheet of the print job detected by the second line sensor S5. Thus, the exposure portion 511 can form an image on the photosensitive drum at a timing earlier than the timing at which the exposure portion 511 forms the image on the photosensitive drum for the first sheet of the printing job in the print job, so that the time in which the sheet S is stopped as in Step S22 can be shortened. As a result, the productivity can be increased.

After the steps S25 and S29, based on the detection result of the leading-edge sensor S6, the control portion 9 controls the conveyance speed of the sheet S by controlling the speed of the second registration-roller pair 102 in accordance with the timing at which an image is transferred in the secondary transfer nip N1 (Step S26).

As illustrated in FIG. 11, a toner image is transferred to the sheet S in the secondary transfer nip N1 (Step S30). Then, the control portion 9 releases the nip NP2 of the second registration-roller pair 102 by driving the second registration separation motor MA5 (Step S31). Furthermore, the control portion 9 fixes the toner image to the sheet S in the fixing unit 58 (Step S32), and discharges the sheet S to the discharging tray 500 (Step S33). With this operation, the sheet conveyance control ends.

In a case where an image is formed on the second side of a sheet S in the double-side printing, the sheet S is conveyed to the registration unit 100 from the vertical path 111, without passing through the registration unit 240 of the sheet feeding apparatus 2. Thus, the processes of the steps S18 to S21 and S27 to S33 of the flowcharts of FIGS. 4 and 5 are performed on the sheet S on which the double-side printing is performed.

The above description has been made for the example where the sheet S is fed from the feeding deck 50U. Similarly, also in a case where the sheet S is fed from the feeding deck 50M, the above-described control illustrated in the flowcharts of FIGS. 4 and 5 is performed. In addition, in a case where the sheet S is fed from the feeding deck 50L, the above-described control is similarly performed except that the sheet S is conveyed by the lower conveyance-roller pair 246 through not the upper conveyance path 241 but the lower conveyance path 242.

Furthermore, in a case where the sheet S is fed from the feeding cassette 50H of the image forming apparatus 1, the sheet S is conveyed from the vertical path 111 to the registration unit 100 as in a case where an image is formed on the second side of a sheet S in the double-side printing, and the skew correction and the movement (shift) of the sheet S in the width direction W are performed in the registration unit 100. In other words, the sheet S fed from the feeding unit 40H of the image forming apparatus 1 is conveyed by the registration unit 100, without passing through the registration unit 240, and thereafter an image is formed on the sheet S by the image forming portion 513.

As described above, in the present embodiment, the sheet S fed from the feeding deck 50L, 50M, or 50U of the sheet feeding apparatus 2 is subjected to the first skew-correction process and the first moving process by the registration unit 240 of the sheet feeding apparatus 2. Furthermore, the sheet S is at least subjected to the second skew-correction process by the registration unit 100 of the image forming apparatus 1. Thus, significant skew and positional deviation in the width direction W are corrected in the first skew-correction process and the first moving process.

In addition, after the execution of the first moving process, so-called re-occurrence of skew that causes the skew of the sheet S may occur. The re-occurrence of skew is caused, in particular, in a case where a portion of the sheet S that is being subjected to the first moving process is in a curved conveyance path (e.g., the upper conveyance path 241 or the lower conveyance path 242). However, even in a case where the re-occurrence of skew occurs and the sheet S is skewed again, the skew of the sheet S is corrected in the second skew-correction process. Therefore, the skew and positional deviation of the sheet S can be corrected with high accuracy.

In addition, in the present embodiment, the so-called side registration system in which the skew of the sheet S is corrected while the sheet S is abutted against the reference member is not used. Specifically, the skew of the sheet S is corrected by abutting the sheet S against the nip NP1 of the first registration-roller pair 243 and the nip NP2 of the second registration-roller pair 102. Thus, the long and linear conveyance path used in the side registration system is not necessary, so that the apparatus can be downsized. For example, the upper conveyance path 241 and the lower conveyance path 242 through which the sheet S fed from the feeding deck 50L, 50M, or 50U passes can be curved, so that the size of the sheet feeding apparatus 2 in the horizontal direction can be reduced.

In addition, in the present embodiment, the sheet S is fed by the air blowing portion and the suction feeding portion. Since such a feeding portion that has the air feeding system is used, the feeding portion can feed a variety types of sheets S, and can increase the types of media that the feeding portion can handle. In a case where the feeding portion that has the air feeding system is used, the sheet S may be skewed or deviate in position when fed. In the present embodiment, however, since the first skew-correction process, the first moving process, and the second skew-correction process are at least performed, the skew and positional deviation of the sheet S can be corrected with high accuracy. That is, in the present embodiment, the image forming system 10 can handle a variety of types of media, can be downsized, and can correct the skew and the positional deviation in the width direction W, with high accuracy.

The registration unit 240 of the sheet feeding apparatus 2 causes the first registration-roller pair 243 to correct the skew of the sheet, and causes the first shift-roller pair 244 to move the sheet S in the width direction W. The lower conveyance path 242 of the sheet feeding apparatus 2 of the present embodiment is curved significantly. For example, in a case where a thin paper sheet that has less grammage is fed, and where the sheet is abutted against the nip NP1 of the first registration-roller pair 243 and forms a loop in the loop space SP2 of the lower conveyance path 242, the sheet may buckle. For this reason, in a case where a thin paper sheet or the like is fed, the first registration-roller pair 243 may not perform the first skew-correction process, the first shift-roller pair 244 may not perform the first moving process, and the second registration-roller pair 102 of the image forming apparatus 1 may perform the second skew-correction process and the second moving process.

In addition, in a case where a thick paper sheet that has more grammage is fed, since the loop space SP4 is smaller than the loop space SP2, the loop may not be formed appropriately in the loop space SP4 at the second registration-roller pair 102, so that the skew of the sheet may not be corrected. For this reason, in a case where a thick paper sheet or the like is fed, the first registration-roller pair 243 may perform the first skew-correction process, the first shift-roller pair 244 may not perform the first moving process, and the second registration-roller pair 102 of the image forming apparatus 1 may perform the second moving process without performing the second skew-correction process. Thus, since the first registration-roller pair 243 and the first shift-roller pair 244 are disposed, separated from each other, in the registration unit 240 of the sheet feeding apparatus 2, an appropriate process can be performed on the sheet in accordance with the grammage of the sheet.

### Other Embodiments

Note that although the registration unit 240 includes the first registration-roller pair 243 and the first shift-roller pair 244 in the above-described embodiment, the present disclosure is not limited to this. For example, the first shift-roller pair 244 may not be disposed, and the first registration-roller pair 243 may perform the first skew-correction process and the first moving process. In addition, although the registration unit 100 includes, in the above-described embodiment, the second registration-roller pair 102 that can perform the second skew-correction process and the second moving process, the present disclosure is not limited to this. For example, the registration unit 100 may include a registration roller pair that performs the second skew-correction process, and a shift roller pair that performs the second moving process.

In addition, although the skew correction process is performed, in the above-described embodiment, by abutting the leading edge of the sheet against the nip of a registration roller pair, the present disclosure is not limited to this. For example, a shutter that includes an abutment surface may be disposed upstream of the nip of the registration roller pair in the sheet conveyance direction. In this case, the skew correction process may be performed by abutting the leading edge of the sheet against the abutment surface of the shutter.

In addition, although the position in which the photosensitive drum is exposed by the exposure portion 511 is adjusted, in the above-described embodiment, based on the detection result of the second line sensor S5, the present disclosure is not limited to this. For example, the position in which the photosensitive drum is exposed by the exposure portion 511 may not be changed.

In addition, although the registration unit 240 is disposed in the sheet feeding apparatus 2 and the registration unit 100 is disposed in the image forming apparatus 1 in the above-described embodiment, the present disclosure is not limited to this. For example, both of the registration units 240 and 100 may be disposed in the sheet feeding apparatus 2 or the image forming apparatus 1.

In addition, although the air feeding system in which the sheet is fed by the air blowing portion and the suction feeding portion is used in the above-described embodiment, the present disclosure is not limited to this. For example, a frictional separation system in which a roller or a pad is used may be used.

In addition, although the first line sensor S3 is disposed, in the above-described embodiment, upstream of the first shift-roller pair 244 in the sheet conveyance direction D, the present disclosure is not limited to this. For example, the first line sensor S3 may be disposed downstream of the first shift-roller pair 244 in the sheet conveyance direction D. Similarly, although the second line sensor S5 is disposed, in the above-described embodiment, upstream of the second registration-roller pair 102 in the sheet conveyance direction D, the present disclosure is not limited to this. For example, the second line sensor S5 may be disposed downstream of the second registration-roller pair 102 in the sheet conveyance direction D.

In the above-described embodiment, the position of the side edge SE of the first sheet S of a print job is detected by the second line sensor S5; and by using the detection result, the exposure position of an image for the second side of the first sheet of the print job, and the exposure position of images for the second and following sheets are adjusted. However, the position of the side edge SE of each sheet S conveyed may be detected by the second line sensor S5, and the position in which the photosensitive drum is exposed by the exposure portion 511 may be adjusted by using the detection result of the second line sensor S5 for each sheet.

In addition, although the second moving process by the second registration-roller pair 102 is not performed, in the above-described embodiment, on the first sheet S of a print job, the present disclosure is not limited to this. For example, the second moving process as in Step S29 may be performed after Step S25.

The present disclosure can correct the skew and positional deviation of the sheet with high accuracy.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-022118, filed Feb. 14, 2025, which is hereby incorporated by reference herein in its entirety.

What is claimed is:

1. A sheet conveyance apparatus comprising:
a feeding unit configured to feed a sheet;
an image forming portion configured to form an image, on a sheet fed by the feeding unit, at an image forming position;
a first conveyance unit disposed between the feeding unit and the image forming position in a sheet conveyance direction and configured to convey the sheet; and
a second conveyance unit disposed between the first conveyance unit and the image forming position in the sheet conveyance direction and configured to convey the sheet;
wherein the first conveyance unit includes:
a first skew-correction portion including a first abutment portion configured to correct skew of the sheet by a leading edge of the sheet abutting against the first abutment portion; and
a shift roller pair disposed downstream of the first skew-correction portion in the sheet conveyance direction and configured to move the sheet in a width direction orthogonal to the sheet conveyance direction while nipping the sheet, and
wherein the second conveyance unit includes a second skew-correction portion including a second abutment portion configured to correct skew of the sheet by the leading edge of the sheet abutting against the second abutment portion.

2. The sheet conveyance apparatus according to claim 1, further comprising:
an image forming apparatus including the second conveyance unit and the image forming portion; and
a sheet feeding apparatus including the feeding unit and the first conveyance unit, the sheet feeding apparatus being connected to the image forming apparatus.

3. The sheet conveyance apparatus according to claim 2, wherein the image forming apparatus includes a main-body feeding unit configured to feed a sheet, and
wherein the image forming portion forms an image on the sheet after the sheet fed from the main-body feeding unit is conveyed by the second conveyance unit without passing through the first conveyance unit.

4. The sheet conveyance apparatus according to claim 1, wherein the first conveyance unit includes a side-edge detection portion configured to detect a position of a side edge of a sheet in the width direction, and
wherein the shift roller pair is configured to move the sheet in the width direction based on a detection result of the side-edge detection portion.

5. The sheet conveyance apparatus according to claim 4, wherein the first conveyance unit includes:
an upstream conveyance-roller pair disposed upstream of the first skew-correction portion in the sheet conveyance direction; and
a guide portion configured to guide the sheet, conveyed by the upstream conveyance-roller pair, toward the first abutment portion of the first skew-correction portion while curving the sheet.

6. The sheet conveyance apparatus according to claim 5, wherein the guide portion includes:
a first guide; and
a second guide that face the first guide and is movable away from the first guide by being pressed by a sheet that has abutted against the first abutment portion.

7. The sheet conveyance apparatus according to claim 1, wherein the feeding unit includes:
a sheet support portion configured to support a sheet;
an air blowing portion configured to blow air on an edge portion of the sheet supported by the sheet support portion to float the sheet; and
a suction feeding portion configured to suck and feed the sheet floated by the air blowing portion.

8. The sheet conveyance apparatus according to claim 4, wherein the second skew-correction portion is configured to move the sheet in the width direction while nipping the sheet, after correcting the skew of the sheet by causing a leading edge of the sheet to abut against the second abutment portion.

9. The sheet conveyance apparatus according to claim 8, wherein the side-edge detection portion is a first side-edge detection portion,
wherein the second conveyance unit includes a second side-edge detection portion configured to detect a position of a side edge of a sheet in the width direction, and
wherein the second skew-correction portion is configured to move the sheet in the width direction while nipping the sheet based on a detection result of the second side-edge detection portion.

10. The sheet conveyance apparatus according to claim 9, wherein the image forming portion includes:
a photosensitive member;
an exposure portion configured to form an electrostatic latent image on the photosensitive member by exposing the photosensitive member; and
a developing portion configured to develop the electrostatic latent image as a toner image, and
wherein the exposure portion is configured to adjust a position of the electrostatic latent image in the width direction based on a detection result of the second side-edge detection portion.

11. The sheet conveyance apparatus according to claim 8, wherein the second skew-correction portion is configured not to move a first sheet of a job, in which sheets are fed by the feeding unit, in the width direction and configured to move second and subsequent sheets of the job in the width direction.

12. The sheet conveyance apparatus according to claim 1, wherein the first skew-correction portion includes a first registration-roller pair configured to form a nip as the first abutment portion, and
wherein the second skew-correction portion includes a second registration-roller pair configured to form a nip as the second abutment portion.

13. A sheet conveyance apparatus comprising:
a feeding unit configured to feed a sheet;
an image forming portion configured to form an image, on a sheet fed by the feeding unit, at an image forming position; and
a conveyance unit disposed between the feeding unit and the image forming position in a sheet conveyance direction and configured to convey the sheet,
wherein the conveyance unit includes:
a skew correction portion including an abutment portion configured to correct skew of the sheet by a leading edge of the sheet abutting against the abutment portion; and
a shift roller pair disposed downstream of the skew correction portion in the sheet conveyance direction and configured to move the sheet in a width direction orthogonal to the sheet conveyance direction while nipping the sheet.

14. A sheet conveyance apparatus comprising:
a feeding unit configured to feed a sheet;
an image forming portion configured to form an image, on a sheet fed by the feeding unit, at an image forming position;
a first conveyance unit disposed between the feeding unit and the image forming position in a sheet conveyance direction and configured to convey the sheet; and
a second conveyance unit disposed between the first conveyance unit and the image forming position in the sheet conveyance direction and configured to convey the sheet,
wherein the first conveyance unit is configured to perform a first skew-correction process of correcting skew of the sheet, and a moving process of moving the sheet, on which the first skew-correction process has been performed, in a width direction orthogonal to the sheet conveyance direction,
wherein the second conveyance unit is configured to perform a second skew-correction process of correcting skew of the sheet on which the first skew-correction process and the moving process have been performed by the first conveyance unit, and
wherein the feeding unit includes:
a sheet support portion configured to support a sheet;
an air blowing portion configured to blow air on an edge portion of the sheet support portion to float the sheet; and
a suction feeding portion configured to suck and feed a sheet floated by the air blowing portion.

15. The sheet conveyance apparatus according to claim 14, wherein the moving process is a first moving process, and
wherein the second conveyance unit is configured to perform a second moving process of moving the sheet, on which the second skew-correction process has been performed, in the width direction.
